(19) United States
(12) Patent Application Publication
(10) Pub. No.: US 2005/0106347 A1
(43) Pub. Date: May 19, 2005

(54) Interlocked strip structure

(76) Inventor: Michael W. Wilson, Sackville (CA)

Correspondence Address: BARNES & THORNBURG, P.O. BOX 2786, CHICAGO, IL, 60690-2786, US

(21) Appl. No.: 10/501,617

(22) PCT Filed: Jan. 17, 2003
(86) PCT No.: PCT/CA03/00054

Related U.S. Application Data
(60) Provisional application No. 60/348,653, filed on Jan. 17, 2002.

(51) Int. Cl. B32B 1/08

(52) U.S. Cl. 428/36.9; 428/99

(57) ABSTRACT

An interlocked ribbed structure, such as a helically wound pipe, comprising a strip clamp. The interlocked ribbed structure is formed of a strip (10) and a strip clamp (28), the strip comprising a base (12) having first and second parallel edges extending along the strip and a series of ribs (14) upstanding from and also extending along the base, wherein the first edge has a first interlocking component (16) and the second edge has a second interlocking component (18), the first interlocking component (16) capable of interlocking with the second interlocking component (18) to form a joint (26), the strip clamp (28) being capable of compressing the joint (26) to ensure joint seal integrity and to reinforce the interlocked ribbed structure.

### FIELD OF THE INVENTION

The present invention relates to an interlocked strip structure which is secured with a strip clamp.

### BACKGROUND OF THE INVENTION

Typically, culverts and pipes used to transport water or other fluids are buried underground and, as a result, have significant forces exerted upon them. A problem with this type of culvert is that in order to compensate for such forces, costly thicker-walled culverts and pipes have been used. Furthermore, transportation of such pipes can be quite cumbersome. Accordingly, strips which can be transported, preferably in coils, and which are capable of being helically wound on site to join its contiguous edges so as to form a pipe, such as described in U.S. Pat. No. 3,938,558 are thought to overcome the above problem.

Several helical or spiral pipes made from such strips provide a substitute for thick-walled pipes. The helical pipes are usually made of plastic material with a ribbed configuration. Canadian Patents 1,142,725 and 1,282,571 and U.S. Pat. No. 4,301,200 describe a strip of plastic material with a ribbed or web configuration, helically wound into a pipe. The pipe may include a band, which may be metal, fitted into spaces between the ribs of the pipe to provide reinforcement. These particular pipes on their own, however, are not airtight and therefore require sealants to seal joining edges of the pipe to provide an airtight seal. Such injection of sealant during pipe assembly has to be carried out in a factory setting. This would be difficult to achieve in the field.

It is therefore an object of an aspect of the present invention to provide an interlocked ribbed structure that obviates or mitigates at least one of the disadvantages set forth above.

### SUMMARY OF THE INVENTION

According to an aspect of the invention, an interlocked structure formed from a strip and a strip clamp,
the strip comprises a base having first and second parallel edges extending along the strip and a series of integral reinforcements upstanding from the base and extending therealong, the first edge has an interlocking component and the second edge has a second interlocking component, the first interlocking component being capable of being interlocked within the second interlocking component to form a joint where at least the first interlocking component has an undercut portion along a side thereof,
the strip clamp being capable of compressing the joint at least in the region of the undercut to secure the joint.

According to another aspect of the invention, a tubular structure formed of a helically wound strip joined along its edges and held secure by a strip clamp,
the strip having a male portion along one edge of a base for the strip, such male portion including a web as part of a connection of the portion to the base and having a female portion for capturing the male portion to form a joint, the male portion including an undercut portion, the strip clamp having leg portions for clamping the female portion beneath the male undercut portion.

According to another aspect of the invention, a structural strip for use in forming a tubular structure by helically winding the strip and interconnecting the strip edges,
the strip comprising a base having first and second parallel edges extending along the strip and a series of integral reinforcements upstanding from the base and extending therealong;
the first edge having a male portion which includes a web as part of the connection of the male portion to the base and the second edge having a female portion for capturing the male portion to form a joint;
the male portion including an undercut portion;
the female portion capturing the undercut portion of the male portion; and
the outer surfaces of the female portion having a clamp engaging surface beneath the undercut of the male portion so that the interconnected joint may be secured by way of the strip clamp.

According to a further aspect of the invention, a concrete composite pipe having a plastic liner comprises a smooth interior surface, as defined by the interior of a tubular structure formed of a helically wound strip joined along its edges and held secure by a strip clamp, the strip having a male portion along one edge of a base for said strip, such male portion including a web as part of a connection of said portion to said base and having a female portion for capturing said male portion to form a joint, said male portion including an undercut portion, said strip clamp having leg portions for clamping said female portion beneath said male undercut portion, the tubular structure being encased in concrete to define the wall thickness of the concrete composite pipe.

### BRIEF DESCRIPTION OF THE DRAWINGS

Preferred embodiments of the present invention will now be described more fully with reference to the accompanying drawings in which:

FIG. 1 is a cross section of a strip of a first embodiment of the invention;

FIG. 2 is a cross section of a portion of the strip of FIG. 1 showing a bead of a first interlocking component of the strip which is engagingly received within a socket of a second interlocking component of the strip to form a joint;

FIG. 3 is the section of FIG. 2 with a strip clamp in place;

FIG. 4 is a perspective view of a tubular structure made from spiral wound strip and the strip clamp of the first embodiment of the invention;

FIG. 5 is a cross section of a strip of a second embodiment of the present invention;

FIG. 6 is a cross section of a portion of the strip of FIG. 5 showing a bead of a first interlocking component of the strip which is engagingly received within a socket of a second interlocking component of the strip to form a joint;

FIG. 7 is the section of FIG. 6 with a strip clamp in place;

FIG. 8 is a perspective view of a tubular structure made from spiral wound strip and the strip clamp of the second embodiment of the invention;

FIG. 9 is a partial longitudinal sectional perspective view of a tubular assembly of the present invention;

FIG. 10 is a longitudinal section of a tubular assembly of the present invention having expanded intermediate sections which are cut to form bell sections for pipe interconnection;

FIGS. 11, 12, 13 and 14 are cross-sections of alternative embodiments for the strip clamp in securing the joint;

FIGS. 15, 16 and 17 are cross-sections of other alternative embodiments for the strip clamp and joint where the rib may be rolled inside the pipe; and

FIG. 18 is a cross-section of concrete pipe with the tubular structure of this invention as the liner for the pipe.

### DETAILED DESCRIPTION OF PREFERRED EMBODIMENTS

The present invention is directed to a strip which can be interlocked into a flat or tubular structure and secured with a strip clamp. The strip comprises a base with two parallel edges extending along the strip, one edge having a first interlocking component and the other edge having a second interlocking component. The first interlocking component is capable of interlocking with the second interlocking component to form a joint. The base usually has reinforcement portions upstanding from the base which may be in the shape of ribs. The strip clamp is capable of compressing the joint to ensure joint seal integrity and to reinforce the interlocked structure. The structure, for example, may be a helically wound pipe or culvert preferably having air-tight properties with substantially increased load carrying properties. The load carrying properties are determined by increased circumferential tensile strength and increased circumferential compression strength. A significant advantage of this invention is that the strip or strips of the present invention may be wound into tubular structures of a variety of diameters which may preferably range from less than 1 ft and up to 10 ft or more. Due to the interlocking feature of the strips, it may be shaped into a variety of tubular shapes such as circular, elliptical, oval and the like.

A strip of a particular strength characteristic may be wound into tubular shapes in a variety of diameters where the strip clamp provides the necessary strength to accommodate the increasing diameter. In accordance with this invention, a particular strength of strip may be used with varying thicknesses and sizes of strip clamps to satisfy a first category of diameters then a second strip design of greater strength characteristics used with various corresponding strip clamps can represent a second category of diameters and so on. This provides enormous flexibility in design for various structural and load-carrying requirements. Furthermore, the structure is of a type that can be assembled in the field with a suitable roller apparatus. Such field assembly of the strip into tubular structures greatly decreases the cost of manufacture of the pipe by virtue of it being made on site and immediately installed to avoid damage, a very significant advantage of the invention. Another significant advantage provided by this invention is that the structures can be made without the need of an expensive manufacturing plant and consequent expensive shipment of large tubular structures.

In another embodiment of the present invention, the interlocked structure maybe formed by interlocking edges of strips and clamping with a strip clamp. Each strip comprises a base with two parallel edges, one edge having a first interlocking component and the other edge having a second interlocking component. The first interlocking component is capable of interlocking with the second interlocking component to form a joint. At the end of one strip, the first interlocking component is capable of interlocking with the second interlocking component of the end of another strip to from another joint. The strip clamp is capable of compressing the joint to ensure joint seal integrity and to reinforce the interlocked structure.

In yet another embodiment of the present invention, the interlocked structure may be formed by interlocking edges of adjacent strips and clamping them with a strip clamp to provide a panel or a culvert.

In accordance with yet another embodiment of the invention, it is understood that the tubular structure may be formed into a round pipe, ovoid pipe, pear-shaped pipe, elliptical-shaped pipe and the like. The pipe may then be cut along its length to provide an arch structure of desired shape. This structure could then be used as a support arch for right over burden in providing a walkway over a stream or the like.

The strips of the present invention may be made from any suitable resilient material. For instance, the material may be chosen from extruded polymers and/or copolymers of varying densities such as polyethylene, polypropylene, polyvinyl chloride, more preferably, polyvinyl chloride or high density polyethylene. The material may be fibre reinforced extruded plastics such as glass or carbon fibre reinforced. The material may also be made from metals such as aluminum, aluminized steel, uncoated steel, galvanized steel and polymer coated steels.

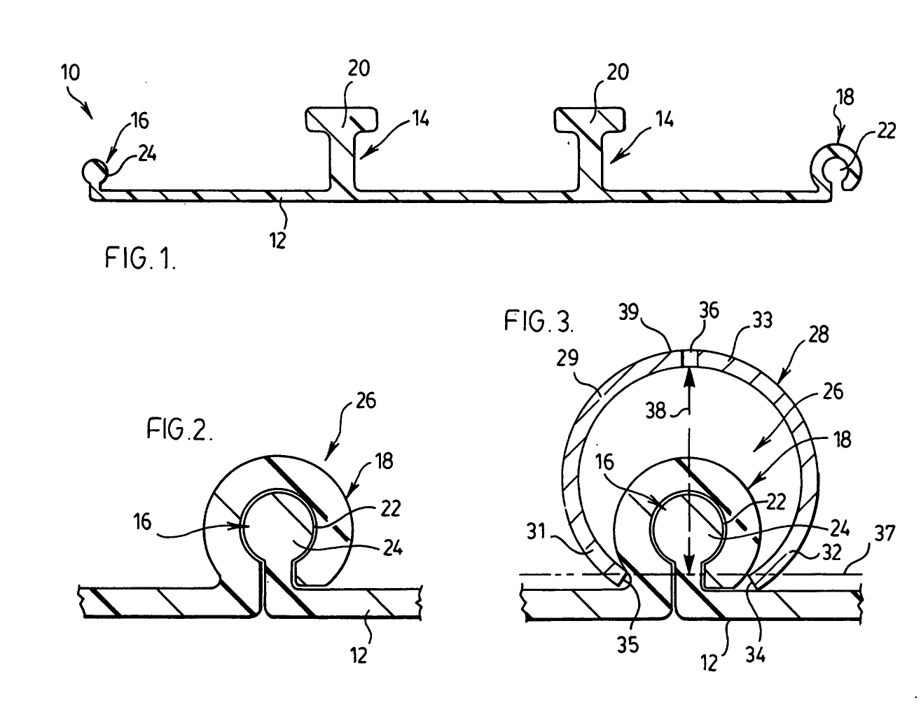

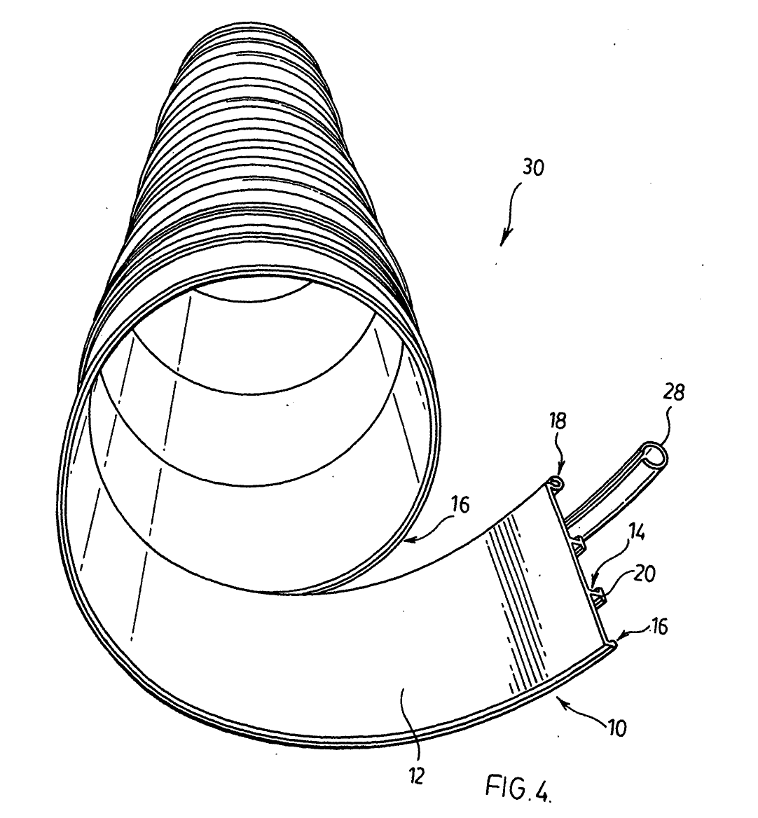

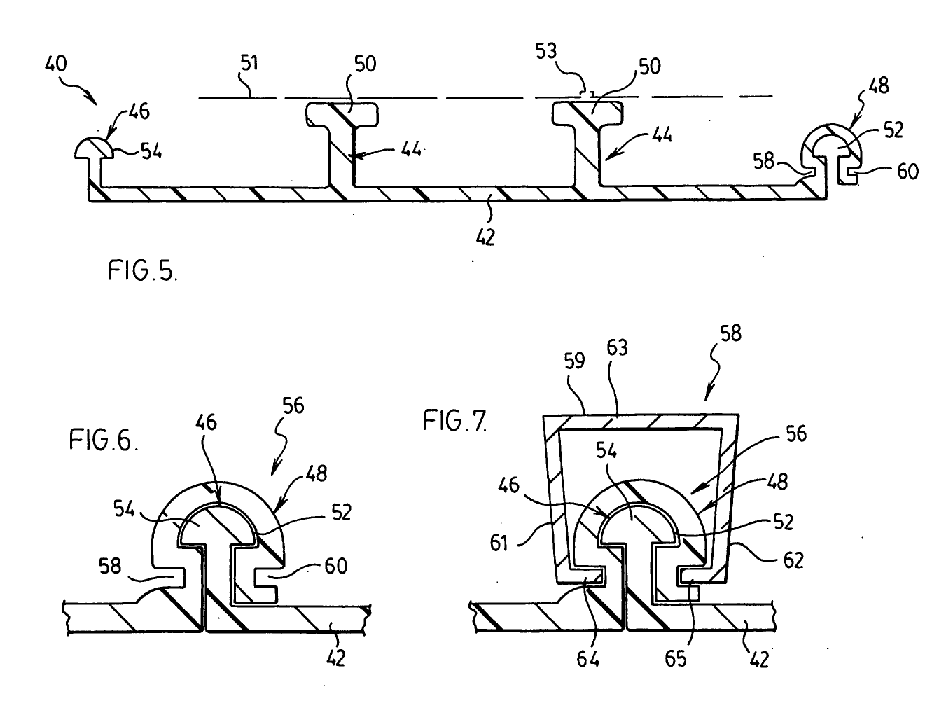

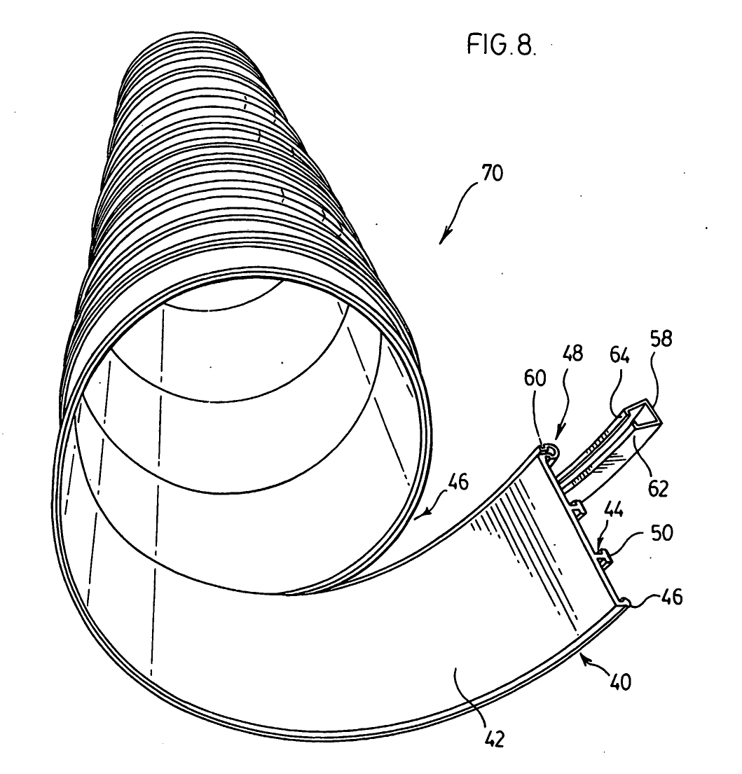

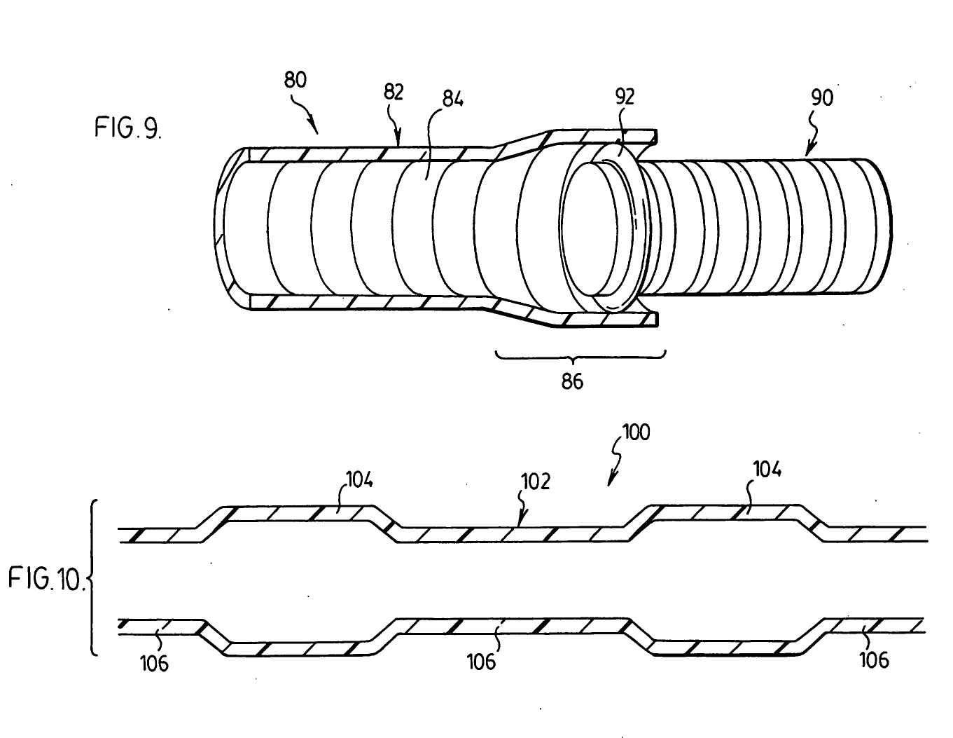

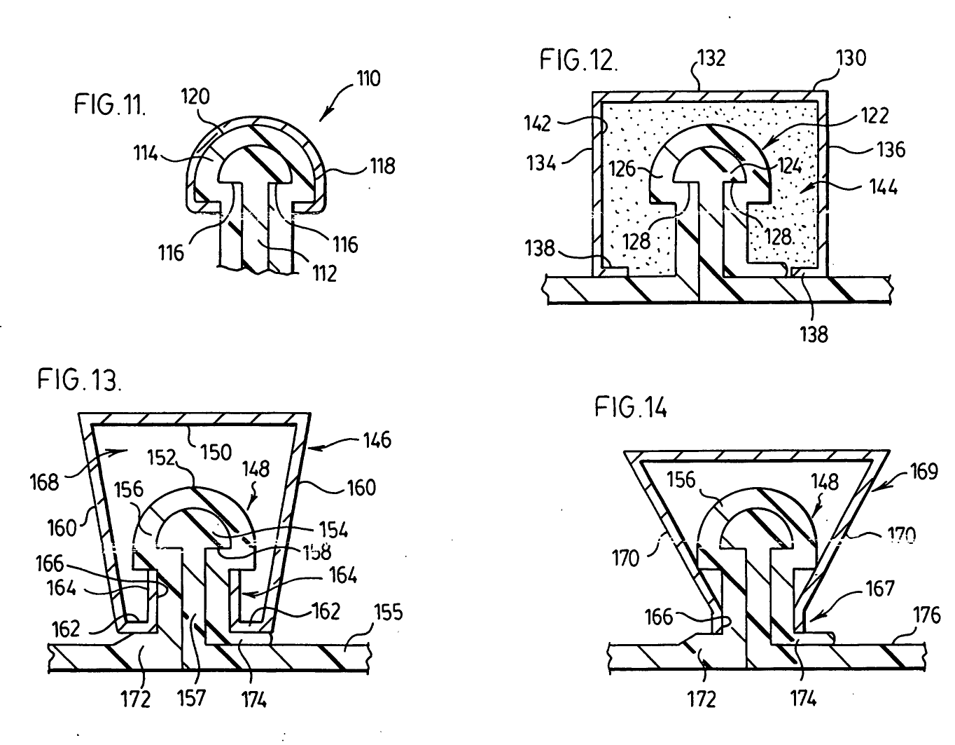

The strip clamp of the present invention may be made from any suitable resilient structural material. For instance, the material may be chosen from extruded polymers and/or copolymers of varying densities such as polyethylene, polypropylene, polyvinyl chloride, more preferably, polyvinylchloride or high density polyethylene. The material may be fibre reinforced extruded plastics such as glass or carbon fibre reinforced. The material may also be made from metals such as aluminum, aluminized steel, uncoated steel galvanized steel and polymer coated steels. In most applications the strip clamp will be formed from metals having a low ductility, such as aluminum alloys, aluminized steels galvanized steel and polymer coated steels. The metal may be of various gauges to achieve the desired strength in respect of clamping the joint to withstand the loads anticipated by the type of pipe installation and its diameter. The strength of the strip clamp can accommodate wide ranges of cover for the pipe. For example, the strip may have sufficient strength to accommodate 10 feet of overburden but by simply changing the size of the strip clamp, that overburden may be doubled or increased by even more. Significant design advantages can be achieved by varying the strength of the strip clamps. In accordance with the preferred embodiment of the invention, the strip clamp may be of various gauges of steel ranging from the lighter 20 gauge material (1.0 mm) to 18 gauge material (1.3 mm). For much larger applications even heavier gauge steel may be used such as 16 gauge (1.6 mm). Referring to the drawings and, initially, to FIG. 1, there is illustrated a strip 10 comprising a base 12, a series of integral ribs 14 upstanding therefrom, a first interlocking component 16 at one edge of the base 12 and a second interlocking component 18 at the other edge of the base 12. To strengthen the ribs 14, the ribs 14 have an integral T-shaped structure as defined by the flanges 20 at their outer ends. It is appreciated of course that the ribs may be have various cross-sectional shapes, depending upon the load-carrying characteristics of the strip. It is also appreciated that other types of reinforcement may be provided on the strip, for example, the strip may have integrally formed web sections connecting an outer strip to the inner strip, the web sections may be configured to define a plurality of hollow cavities between the inner and outer strips.

The second interlocking component 18 has a socket 22, as shown in FIG. 2. The first interlocking component 16 has a bead 24, which is shaped to be engagingly received within the socket 22 of the second interlocking component 18 to provide a joint 26.

In accordance with a first embodiment of the present invention, FIG. 3 shows the bead 24 of the first interlocking component 16 being engagingly received within the socket 22 of the second interlocking component 18 to form the joint 26. The joint 26 is compressed and reinforced with a strip clamp 28 to ensure joint seal integrity and to reinforce the resultant interlocked ribbed structure. The strip clamp 28 in this particular embodiment is circular or semi-circular in section. The strip clamp has a one-piece body portion 29 with opposing arms 31 and 32. The opposing arms 31 and 32 are interconnected by circular portion 33. The arms 31 and 32 have ends 34 and 35 which clamp beneath the second interlocking component 18 to secure the joint by clamping the socket 22 closed. The strip clamp of the present invention may have a variety of shapes other than the circular or semi-circular section. The strip clamp may for instance have a square or rectangular section where the legs of the rectangular square section either slope inwardly towards each other or outwardly away from each other. The strip clamp may contact the joint outer surface or may be spaced therefrom.

To provide for increased structural strength, for example, the outermost structural core represented by portion 36, is spaced a significant distance from the clamp axis 37. By virtue of this spacing of the cord 36 from the clamp axis 37, the clamp strips provide significant reinforcing strength to the joint and also to the structure. The extended moment arm 38 resists bending of the strip clamp, particularly inward bending. This adds considerable strength to the assembled structure which is usually a pipe or culvert.

FIG. 4 shows how a tubular structure 30, such as a pipe, is formed when a strip 10 is helically wound and the edges inter-engage by forcing the first interlocking component 16 into the socket 22 of the second interlocking component 18 thereby forming the joint 26. The formation of the joint may be accomplished by use of a pinch roller assembly. The joint 26 is compressed and reinforced by a strip clamp 28. The strip clamp 28 may feed through an additional roller of the pinch roller assembly to complete the joint. The strip clamp 28 has the extended moment arm 38 and is at a height which preferably corresponds to the height of the flanges 20, which gives the tubular structure 30 greater strength from deformation or buckling of the cylindrical shape of the structure 30.

Although it is understood that depending upon the end use of this tubular structure, strip clamp upper edge 36 which is the outer extremity of moment arm 38, may be shorter than or taller than the height of flange 20. Depending upon the application for the tubular structure, the height of the clamp, particularly if it is metal, and the gauge of the clamp, can greatly alter the strength characteristics for the structure thereby enhancing the choice of diameters for a particular strength of the chosen strip. It is also understood that the strip clamp, particularly for a larger diameter pipe, will normally be of heavier gauge metal and will be considerably higher than the flange portion 20 of the reinforcement Ts to provide thereby the increased circumferential strength for a large diameter pipe.

FIG. 5 shows an alternative embodiment of the strip. A strip 40 comprises a base 42, a series of integral ribs 44 upstanding therefrom, a first interlocking component 46 at one edge of the base 42 and a second interlocking component 48 at the other edge of the base 42. To strengthen the ribs 44, the ribs 44 have flanges 50 at their outer ends.

The second interlocking component 48 has a socket 52 as shown in FIG. 6. The first interlocking component 48 has a bead 54, which is shaped to be engagingly received within the socket 52 of the second interlocking component 48 to form a joint 56. The second interlocking component 48 has chamber 58 and 60 extending along the length of the component 48.

In accordance with the second embodiment of the present invention, FIG. 7 shows the bead 54 of the first interlocking component 48 being engagingly received within the socket 52 of the second interlocking component 48 to form the joint 56. The joint 56 is compressed with an alternative strip clamp 58 to ensure joint seal integrity and to reinforce the resultant interlocked structure. The strip clamp 58 in this particular embodiment is a hollow semi-rectangular parallellepiped having a one-piece body portion 59 with clamp arms 61 and 62 interconnected by a planar reinforcing rib 63. The opposing clamp arms 61 and 62 have opposite clamp jaws or ends 64 and 65. The clamp jaws 64 and 65 are engagingly received within the channels 58 and 60 of the second interlocking component 48, beneath the bead 54.

As shown in FIG. 5, the strip 40 may have on its outer surface, a membrane 51. The membrane may be fused at joint 53 which most preferably is fused at the flange 50. In addition, the membrane may be fused to the flanges 50 to secure the membrane in place. The membrane could add additional strength to the pipe wall. The membrane in covering the steel strip 58 and sealing the area around the steel strip would eliminate the need to coat the steel strip in protecting the strip from a concrete environment. The spaces defined by the membrane, between the flanges 50 could be filled with concrete or other suitable filler to strengthen the pipe. The spaces could be filled as the strip and membrane is being wound to form the pipe. With reference to the earlier discussion of the reinforcement, such as the T-sections and the use of an outer strip, this structure would be similar to that described with respect to FIG. 5. The outer membrane 51 could in essence be the same thickness as base 12 of the existing strip 10 and integral with the flange portions 50 of the Ts or other web portions interconnecting base 12 to the upper web or strip to provide thereby box-like reinforcements on the strip base 12.

FIG. 8 shows how a tubular structure 70, such as a pipe, is formed by feeding the strip 40 into a strip spiral winding apparatus (not shown). Such apparatus has an appropriate roller or pressing assembly to wind the strip helically and engage the joint. Usually, the strip 40 is helically wound and the edges interengage by feeding them through a roller assembly and forcing the first interlocking component 46 into the socket 52 of the second interlocking component 48 forming the joint 56. The joint 56 is compressed and reinforced by a strip clamp 58 which is also fed through a roller assembly. The strip clamp 58 has an extended moment arm defined by planar reinforcing rib 63 and is at a height that corresponds to the height of the flanges 50, which gives the tubular structure 70 greater strength from deformation or buckling of the cylindrical shape of the structure 70.

In accordance with other embodiments of the invention, the pipe of the invention may be joined to another pipe or culvert through a bell connection. FIG. 9 shows a tubular assembly 80. A tubular structure 82 is formed, as described above, when a strip 84 is helically wound and the edges are forced together. The radius of winding of the strip 84 is increased as it approaches the end of formation of the tubular structure 82. As a result, the tubular structure 82 has a larger diameter at one end portion of the tubular structure 82 to define a bell connector 86. The end of bell 86 of the tubular structure 82 receives a spigot 90 of the other end of a pipe section. A ring seal 92 is used to seal the bell 86 and the spigot 90 to one another. The seal 92 may be any type of seal material that allows for expansion and construction of the tubular structures while retaining the desired seal. The seal 92 may create an airtight seal or may simply be a connector suitable for holding the tubular structures together. The seal 92 may be a bonding material, such as glue or cement, or a snug fitting o-ring. The seal 92 may also be a circular clamp surrounding the outside of the bell 86, which clamps it to the inner spigot 90. Preferably, the seal is a compressible-type of seal, such as closed cell foam, placed at the end of the spigot 90, wherein the compressible-type of seal is compressed when the spigot is inserted into the bell 86 and, once seated, expands to conform to the interior surface of the bell 86.

In other embodiments, it may be the smaller diameter section of the tubular structure 82 that acts as the spigot and is received within another tubular structure.

To make the tubular structure 82 as shown in FIG. 9, FIG. 10 illustrates a tubular structure 100 prior to formation of the tubular structure 82. The method of making the tubular structure 100 initially involves winding a strip 102 such that the radius of the resulting tubular structure 100 is increased along the strip 102 such that a larger diameter portion 104 of the tubular structure 100 is formed. Secondly, the radius of winding of the strip 102 is decreased along a portion of the strip 102 to form a smaller diameter portion 106 of the tubular structure 100. The process is then repeated depending on how many larger and smaller diameter portions 104 and 106 are needed. The tubular structure 100 is then cut into sections. For instance, the tubular structure may be cut across midway of the larger diameter portions and midway of the smaller diameter portions to yield a tubular structure 82 with the spigot 90 and the bell 86, as shown in FIG. 9. It may also be cut across two larger diameter portions or two smaller diameter portions to yield a tubular structure with two end bells or two spigots, respectively. The length of the resulting bells will vary depending on the diameter of the pipes where the longer the pipe, the large the diameter of the pipe.

With respect to the alternative embodiments for the various connections, reference is made firstly to FIG. 11. A joint 110 has the typical male portion 112 inserted or captured within a female portion 114. The undercut 116 on each side of the male portion is captured by the corresponding interface of the female portion 114. The strip clamp 118 clamps and squeezes together the female portions 114 and is positioned underneath the undercuts 116 in the male portion to secure the connection. The strip clamp 118 is designed to contact the outer periphery 120 of the female portion 114 to encase and provide resistance to flow of the material making up the female portion 114.

The further embodiment of FIG. 12 has a joint structure 122 with the male portion 124 captured in the female portion 126 wherein the undercut portions 128 are captured by the female portion 126. The strip clamp 130 is rectangular with a top 132, sides 134 and 136 inwardly directing leg portions 138 and 140. The strip clamp is sufficiently rigid such that when the cavity defined by the interior surfaces 142 of the strip clamp is filled with a material 144, the joint 122 is secured. The filler material 144 must be sufficiently rigid to prevent movement of the joint which is retained by virtue of the strength of the sidewalls 136. The filler material 144 may be a rigid foam or more rigid materials such as a concrete, cured polyurethanes and the like.

The embodiment of FIG. 13 provides a strip clamp 146 which provides for considerable height above the joint 148. The top chord or top wall 150 of the strip clamp 146 is well above the upper portion 152 of the joint. The joint is constructed in the usual manner having a male portion 154 captured in the female portion 156 with the usual undercuts 158. The second or female portion 156 is captured or squeezed by opposing legs 160. The sidewalls or legs have inwardly directed flanges 162 and then returned edges 164 which present flat surfaces for engaging of the flat surfaces 166 of the joint 148. It is appreciated that the cavity 168 within the strip clamp may be filled with a suitable material to provide additional strength to the connection. The fillers may be either mastic compounds for sealing or rigid foam compounds to add structural strength and a steel to the joint.

The alternative embodiment of FIG. 14 has the joint 148 of FIG. 13 where the flat portions 166 are engaged by depending flats 167 of the legs 170. The flats 167 engage the flat surfaces 166 of the female portion 156 to secure the joint in the like manner of FIG. 13 where the flat portions 164 or 167 avoid biting into the female portion 156 and severing the connection. To ensure that the strip clamp is properly seated, in each of FIGS. 13 and 14 steps 172 and 174 are provided on the second or female joint 156 to ensure that the strip clamp is level with the plane of the base, as defined by line 176.

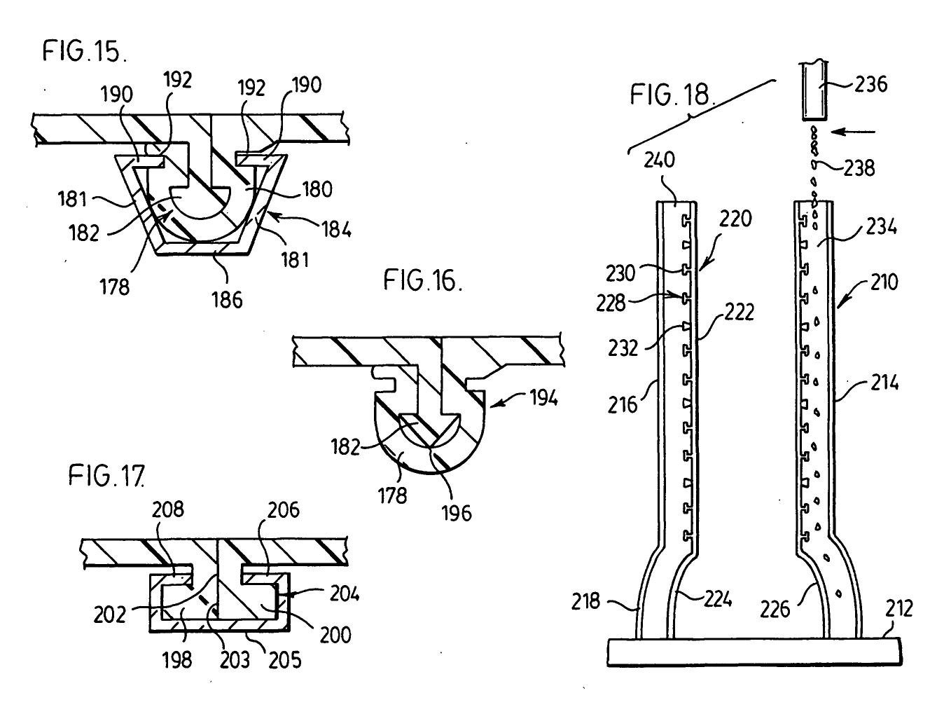

As shown in FIG. 15, a joint 178 is constructed with the usual female portion 180 and male portion 182 interlocked in the normal manner only rolled in a way that the joint 178 projects to the inside of the pipe. A suitable strip clamp 184 is provided. The strip clamp has a base section 186 with opposing legs 188 which are directed outwardly and has inwardly directed clamp portions 190 which are secured in the respective grooves 192 of the female portion.

FIG. 16 shows an alternative embodiment for the joint 194. The female portion 178 is the same as in FIG. 15 only the male component 182 has a tapered end 196 which forms a point, contact and seal with the interior surface 198 of the female portion 178. The joint is clamped in the same manner as FIG. 15 whether the joint be on the inside or the outside of the pipe.

A further embodiment of the invention is shown in FIG. 17 where the joint comprises oppositely opposed L-shaped sections 198 and 200. Both sections have planar face 202 which abut one another when the strips are wound helically. The joint is secured by way of the strip clamp 204 which captures the two L-shaped portions 198 and 200 and pinches them together by virtue of the opposing clamp portions 206 and 208. This connection is best suited for lower load applications. A further variation of the structure of FIG. 17 would include enlarging clamp 204 to provide a space between the clamp base 205 and the extremity 203 of the joint 202. Such spacing, as with the earlier embodiments such as FIG. 3 and FIG. 7, provides increased strength. The space between the base 205 and the extremity 203 of the joint may be filled with a suitable mastic compound or the like to not only strengthen the joint but as well provide additional seal for the interface 202 of the joint. This arrangement would, for example, prevent water from leaking inwardly or outwardly of the joint.

One of the significant advantages of the design, for example, shown in FIG. 13, is that the male portion 154 is connected to the base 155 by way of a web component 157. The web is part of the male component for fitment within the female component and it is understood that the web may be only part of the interconnection from the male component head portion to the base 155. In any event, the clamping action of the strip clamp 146 secures the head 159 of the male portion 154 and the female portion 156. The claming pressure can be designed to be sufficiently significant that the structural strength of the tubular member is determined by the strength of the web 157. The clamping pressure is such that failure of the tubular structure only occurs when the web 157 is severed, which provides for a significant advantage in design considerations. The strip may be engineered to provide a thickness for the web 157 which will fail at a predetermined tensile strength. This provides a relatively simple design criteria for the tubular structure. Failure of the tubular structure is determined by the tensile strength of the web so that varying the thickness and characteristics of the web material rarely determines the structural strength of the tubular structure. That feature in combination with the strength of the strip claim 146 provides for a well engineered structure as well as a very strong structure.

FIG. 18 demonstrates one way in which the tubular structure of this invention may be used as a corrosion resistant liner for concrete pipe. As shown in FIG. 18, an exterior pipe mold 210 is positioned on a platform 212. The exterior mold has an outer shell 214 which has a first diameter in region 216 and extended out to a second diameter in region 218. The interior mold may be provided in accordance with the embodiments of this invention by the tubular structure 220 which mirrors the shape of the exterior pipe mold 210. Inner mold 220 has a first diameter 222 which is the interior diameter for the pipe and a second interior diameter 224 which defines the receiving portion for the pipe end to be connected thereto. The portion 226 which defines the lower part of the inner pipe mold may be formed from the pipe structure 220 or may be a separate injection molded plastic member. The interior pipe mold 220 is formed from a tubular structure of the strip and the strip clamp of this invention. A smooth interior wall is provided along section 222. The exterior portion 228 has the usual reinforcements 230 and strip clamps 232.

An annular cavity 234 is defined between the exterior pipe mold and the interior pipe mold. That cavity is filled with concrete from a concrete nozzle 236 which dispenses concrete 238 downwardly into the opening 240 of the annular cavity 234. The base 212 may be a vibrating base to settle the concrete in the pipe mold and to thereby complete the forming of the pipe. Once the concrete is set, the exterior pipe mold is removed to provide a concrete pipe with a corrosion-resistant plastic liner which is smooth walled having a very low hydraulic co-efficient (ManningsN).

A further benefit in the design of the structural pipe is that lateral connections are readily made. A hole may be cut in the side of the form pipe of a desired diameter. A wrap, preferably of rigid plastic or metal, may be secured about the perimeter of the pipe to which a side or lateral pipe may be connected. If the strip clamps are metal then preferably the reinforcement wrap is also metal so that the reinforcement wrap may be welded to the strip clamp to provide permanent connection of the reinforcement wrap about the cut opening. The lateral pipe may as well have a reinforcement wrap which then fits within the aperture of the reinforcement wrap on the main pipe and a welded connection can be made to secure the lateral pipe in place.

In accordance with other embodiments, a first strip (i.e. 10 or 40) of this invention may be helically wound and connected as taught above. Another strip may be subsequently attached to the end of the first strip by inter-engaging the first interlocking component of the first strip with the second interlocking component of the other strip or vice-versa to connect several structures together, in particular, tubular structures. In the case of tubular structures, the structures may be fused together with a sealant by joining the end of the first strip to the end of the second strip to provide an airtight seal at this joint. In this particular instance, much less sealant would be used compared to that required to seal the helical joint that extends the length of a tubular structure disclosed in the prior art.

In accordance with further embodiments, the strip clamp may not be continuous. Sections of the strip clamp may be used to compress and reinforce the joint formed between the first interlocking component and the second interlocking component. There may be a small spacing, usually less than about 10 cm and more preferably less than about 3 cm along the joint and still maintain a seal at the portion of the joint without a clamp. The clamp strip sections may be fused together at their adjacent ends such as by butt welding whereby no space is provided between the clamps along the joint.

In accordance with other embodiments, the strip of the present invention may be helically wound into a tubular structure such that the ribs are on the outer surface of the tubular structure, thus, providing a smooth inner surface or vice-versa. The ribs form longitudinal channels that may be filled with a material such as concrete to form a helical filler. When the ribs are on the outer surface and the channels are filled with the filler, the strip may act as a liner for the filler

In accordance with other embodiments, the tubular structure of the present invention may be used to reline or encapsulate old tubular structures. This is particularly advantageous when an underground old steel pipe starts to rust, one may line it with the tubular structure of the present invention without having to dig the pipe up. When the ribs are on the outer surface and in contact with the inner surface of the old tubular structure, the channels may be filled with a filler, such as concrete, to fill the annular space between the liner and the inner surface of the old tubular structure.

Alternatively, the strip may be inverted inside out and spiral wound to provide a smooth liner for a corroded or damaged pipe interior. A space may be provided between the liner and the pipe interior which in turn is filled with cement. When the cement sets, the liner may be removed to leave a protection of a concrete liner on the inner surface of the old tubular structure. Of course other alternative structures are contemplated. For example, where it is desired to improve the hydraulic efficiency of corrugated steel pipe, the tubular structure of this invention may be used to line corrugated steel pipe to provide a low Mannings number, one that obtains the benefits of the strength of the corrugated steel pipe with the advantages of the smooth plastic liner.

Alternatively, two tubular sections of this invention may be formed where the inner tubular section has the smooth side on the inside and the outer tubular section which is spaced from the inner one, has the smooth side on the outside. The space between the inner and outer tubular sections may be then filled with concrete or the like to provide a concrete pipe which is corrosion protected on the inside and the outside. With this type of structure the provision of the reinforcement Ts and strip clamps within the interior cavity provides undercuts for the concrete to bind and hence, form a very sturdy structure without the need of any other forms of reinforcement in the concrete.

The tubular structure of the present invention may also be used to encapsulate one or more tubular structures of the present invention to provide further reinforcement. Preferably, a strip, as described herein, is wound around the tubular structure of the present invention, more preferably, wound in the opposite direction to that of the strip used to make the tubular structure of the present invention, to provide optimal reinforcement.

The strip and strip clamp of the present invention may also be used to make panels. The strips may be planar sheets wherein adjacent edges of sheets are interlocked, for instance, a bead of a first interlocking component of one sheet is engagingly received within the socket of another sheet of a second interlocking component to provide a joint. The joint being reinforced with a strip clamp to ensure joint seal integrity.

Although preferred embodiments of the present invention have been described, those of skill in the art will appreciate that variations and modifications may be made without departing from the spirit and scope thereof as defined by the appended claims.

1. An interlocked structure formed from a strip and a strip clamp,
the strip comprising a base having first and second parallel edges extending along said strip and a series of integral reinforcements upstanding from the base and extending therealong, the first edge has an interlocking component and the second edge has a second interlocking component, the first interlocking component being capable of being interlocked within the second interlocking component to form a joint where at least the first interlocking component has an undercut portion along a side thereof,
the strip clamp being capable of compressing the joint at least in the region of said undercut to secure said joint.

2. The structure of claim 1 wherein the first and second interlocking components abut one another where each of the first and second interlocking components have an undercut portion along the side thereof of the joint, the strip clamp compressing the joint at the opposite undercuts to secure the joint.

3. The structure of claim 1, wherein the first interlocking component is capable of interlocking with the second interlocking component to form a joint where the first interlocking component has an undercut portion along each side thereof and is captured in the second interlocking component, the strip clamp being capable of compressing the joint at least along the second interlocking component which captures the undercut to ensure joint seal, integrity and to reinforce interlocked ribbed structure.

4. The structure of claim 3, wherein the strip clamp is spaced from the joint to define a cavity along a joint, the cavity being filled with a substantially rigid material to effect the clamping action at least along the second interlocking component which captures the undercut of the first interlocking components.

5. The structure of claim 3, wherein the structure is tubular.

6. The structure of claim 5, wherein the strip clamp is inwardly biased to provide said joint compression at said undercut.

7. The structure of claim 5, wherein the clamp comprises a body portion with opposing arms, the opposing arms having ends which compress the joint.

8. The structure of claim 5, wherein the clamp is semi-cylindrical.

9. The structure of claim 5, wherein said reinforcements are ribs upstanding from said base.

10. The structure of claim 9, wherein the clamp, in place, has a height that corresponds to the height of an outer end of at least one rib.

11. The structure of claim 9, wherein the first interlocking component has a bead and the second interlocking component has a socket, wherein the bead is shaped to be engagingly received within the socket of the second interlocking component.

12. A tubular structure formed of a helically wound strip joined along its edges and held secure by a strip clamp,
the strip having a male portion along one edge of a base for said strip, such male portion including a web as part of a connection of said portion to said base and having a female portion for capturing said male portion to form a joint, said male portion including an undercut portion, said strip clamp having leg portions for clamping said female portion beneath said male undercut portion.

13. The tubular structure of claim 12, wherein said strip clamp exerts sufficient compression on said female component to prevent separation of said joint and when said tubular structure is underload, failure occurring first in severing of said web from the base.

14. The tubular structure of claim 12, wherein the male portion is a bead and the female portion is a socket, the bead being shaped to be engagingly received within the socket of the female portion.

15. The tubular structure of claim 14, wherein the clamp comprises a body portion with opposing arms, the opposing arms each having an end, and at least one end having a clamping portion.

16. The tubular structure of claim 15, wherein the female interlocking component has at least one channel that engagingly receives the clamping portion.

17. The tubular structure of claim 16, wherein the second interlocking component has two channels that engagingly receive two opposing clamping portions.

18. The tubular structure of claim 17, wherein the strip clamp is a hollow semi-rectangular parallelepiped.

19. The tubular structure of claim 14, wherein the base of the strip has integral reinforcement ribs which have an integral flange at their distal end for find a T-shaped supporting structure.

20. The tubular structure of claim 12, where the helical wound strip is made from an extruded polyolefin selected from the group consisting of polyethylene, polypropylene, polyvinyl chloride and co-polymers of varying densities.

21. The tubular structure of claim 20, wherein the selected polyolefin includes at least one of glass and carbon fibre reinforcement.

22. The tubular structure of claim 12, wherein the strip clamp is a rigid plastic or of a metal selected from the group consisting of steel, stainless steel, galvanized steel, aluminum and polymer coated steel.

23. The tubular structure of claim 15, wherein each end of the opposing arms has a clamping portion, the clamping portions being biased towards one another to exert a clamping pressure on the female portion of the joint.

24. The tubular structure of claim 15, wherein the opposing arms are angled inwardly towards each other.

25. The tubular structure of claim 24, wherein the clamping portion at the end of each arm has flat at the end of each arm for engaging the corresponding flat portion on the female portion which is beneath the undercut of the male portion.

26. The tubular structure of claim 25, wherein the flat on each arm is provided by a return on the leg portion.

27. The tubular structure of claim 15, wherein the opposing arms are angled outwardly from each other.

28. The tubular structure of claim 12, wherein the male portion has a tapered end to provide for point contact within the female portion.

29. The tubular structure of claim 12, wherein the formed tubular structure has a diameter, the diameter varying from a first diameter which is representative of the pipe diameter to a second diameter which is representative of the enlarged bell portion of a bell and spigot connection.

30. The tubular structure of claim 29, wherein the enlarged bell portion of the pipe is severed midway and the small diameter for the pipe is severed midway to provide an individual pipe section.

31. A structural strip for use in forming a tubular structure by helically winding the strip and interconnecting it,
the strip comprising a base having first and second parallel edges extending along the strip and a series of integral reinforcements upstanding from the base and extending therealong;
the first edge having a male portion which includes a web as part of the connection of the male portion to the base and a female portion for capturing the male portion to form a joint;
the male portion including an undercut portion;
the female portion capturing the undercut portion of the male portion; and
the outer surfaces of the female portion having a clamp engaging the surface beneath the undercut of the male portion so that the interconnected joint may be secured by way of the strip clamp.

32. A concrete composite pipe having a plastic liner comprises a smooth interior surface, as defined by the interior of a tubular structure formed of a helically wound strip joined along its edges and held secure by a strip clamp, the strip having a male portion along one edge of a base for said strip, such male portion including a web as part of a connection of said portion to said base and having a female portion for capturing said male portion to form a joint, said male portion including an undercut portion, said strip clamp having leg portions for clamping said female portion beneath said male undercut portion, the tubular structure being encased in concrete to define the wall thickness of the concrete composite pipe.
